(19) United States
(12) Patent Application Publication
(10) Pub. No.: US 2017/0171374 A1
(43) Pub. Date: Jun. 15, 2017

(54) Method and electronic device for user manual callouting in smart phone

(71) Applicants: Le Holdings (Beijing) Co., Ltd., Beijing (CN); Lemobile Information Technology (Beijing) Co., Ltd, Beijing (CN)

(72) Inventor: Junkai Yin, Beijing (CN)

(21) Appl. No.: 15/232,944

(22) Filed: Aug. 10, 2016

Related U.S. Application Data
(63) Continuation of application No. PCT/CN2016/088356, filed on Jul. 4, 2016.

(30) Foreign Application Priority Data
Dec. 15, 2015 (CN) 201510931767.0

(51) Int. Cl. H04M 1/725; H04M 15/00; G06F 3/0488; H04L 29/08

(52) U.S. Cl. CPC H04M 1/72522; H04L 67/26; H04M 15/58; G06F 3/0488

(57) ABSTRACT

The application provides a user manual callout method for a smart phone, including the following steps of: setting an application needing to be described; accumulating the usage time or usage count of each application needing to be described according to the set information; and, when the accumulated usage time or accumulated usage count of one application is lower than a set value, pushing description information of the application. The application displays a phone system manual on the left bottom of a lock screen by taking the usage time or usage count as a trigger condition, so as to make a targeted guide description for an application not familiar to or not used in a long period by a user, thereby effectively improving the degree of familiarity of the user with the functions and facilitating the user to use each function of the smart phone better.

### CROSS REFERENCE TO RELATED APPLICATIONS

This application is a continuation application of a PCT application No. PCT/CN2016/088356, filed on Jul. 4, 2016, which claims priority to Chinese Patent Application No. 201510931767.0, entitled “METHOD AND DEVICE FOR USER MANUAL CALLOUTING IN SMART PHONE”, filed on Dec. 15, 2015, the entire contents of which are incorporated herein by reference.

### TECHNICAL FIELD

The application relates to information, and specifically to a user manual callout method and a user manual callout electronic device for a smart phone.

### BACKGROUND

Smart phones have abundant and powerful functions. However, when a user uses the smart phone, if there is no convenient and humanized description, some functions are difficult to be discovered; thus many functions cannot be fully played.

User manual is an application for introducing each operation function in a smart phone. However, to consult a user manual, a user can only enter the system settings to open the application of user manual. At present, there is no method proposed to enable a user manual conveniently, and the system cannot actively help a user to use unfamiliar functions.

### SUMMARY

In view of the drawbacks of the existing technologies, the purpose of the application is to provide a method and an electronic device which can give in time a prompt and description for applications not commonly used by a user.

An embodiment of the application provides a method for user manual callouting in smart phone, including the following steps: S100: setting an application needing to be described; S200: accumulating the usage time or usage count of each application needing to be described according to the set information; and S300: when the accumulated usage time or accumulated usage count of one application is lower than a set value, pushing description information of the application.

The embodiment of the application further provides a nonvolatile computer storage media having computer executable instructions stored thereon, wherein the computer executable instructions can perform the method for user manual callouting in smart phone in any one of the foregoing embodiments of methods.

The embodiment of the application further provides an electronic device, including: one or more processors; and a memory communicably connected with the one or more processors; wherein the memory is stored with instructions executable by the one or more processors, the instructions are executed by one or more processor, such that the at least one processor can perform the method for user manual callouting in smart phone in any one of the foregoing embodiments of methods.

With respect to the existing technologies, the embodiment of the application displays a phone system manual on the left bottom of a lock screen by taking the usage time or usage count as a trigger condition, so as to make a targeted guide description for an application not familiar to or not used in a long period by a user, thereby effectively improving the degree of familiarity of the user with the functions and facilitating the user to use each function of the smart phone better.

### BRIEF DESCRIPTION OF THE DRAWINGS

At least one embodiment is illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a user manual callout method for a smart phone in a specific embodiment of the application.

FIG. 2 is a system diagram of a user manual callout device for a smart phone in a specific embodiment of the application.

FIG. 3A is a screen capture of displaying a description information prompt of a user manual in a screen locked state of a mobile phone in an embodiment of the application.

FIG. 3B is a screen capture of displaying description information in a screen locked state of a mobile phone after a user's finger swipes up in an embodiment of the application.

FIG. 3C is a screen capture of displaying more description information in a screen locked state of a mobile phone after a user's finger continues to swipe up in FIG. 3B.

FIG. 4 is a schematic diagram illustrating a hardware structure of a device of a method for user manual callouting in smart phone according to an embodiment of the application.

### DETAILED DESCRIPTION

In the application, a server end configures the function description in a user manual, that is, if a current user does not use one or some functions during a period of time at a phone terminal, triggering the display of the user manual for a targeted guide description.

The user manual, including the function introduction and usage description of various applications built in the mobile phone, is a specific description for each application.

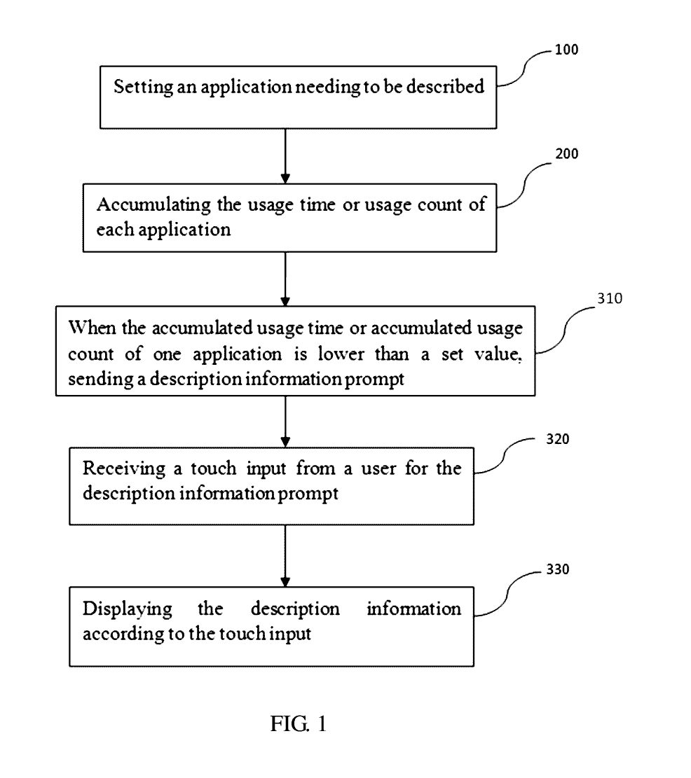

FIG. 1 is a flowchart of a user manual callout method for a smart phone in a specific embodiment of the application, as shown in FIG. 1, the method includes the following steps:

S100: setting an application needing to be described. In this step, an application to be described needing the trigger of the content in a user manual is set; the set content includes the name of the application and the condition for triggering the user manual description of the application. In particular, each application may be a system application built in the mobile phone or an application recommended by a partner. The set content further includes a set trigger condition; the trigger condition is in which condition to push an introduction description of a certain application on a user interface; in the application, the trigger condition may include the usage time of an application or the usage count of an application.

In a preferred embodiment, an application needing to be described is set at a server end and the set information is sent to a phone terminal of a user. In this embodiment, for an application with functions needing to be described, the name and trigger condition are preset in a server, for example, setting “Reminder” and “System Update” as applications with functions to be described and setting the usage time as 2 minutes per month. That is to say, for any one application of “Reminder” and “System Update”, if the usage time of a user is lower than 2 minutes per month, the introduction description is pushed to the user.

S200: accumulating the usage time or usage count of each application according to the set information.

S200 includes two possible techniques: (1) accumulating the usage time of each application; (2) accumulating the usage count of each application. The accumulated usage time is realized through the statistics of the running time of the application, the running time of an application referring to the elapsed time from the start of the application to the stop of the application. Each time an application is detected starting running in a memory, the application is considered to have started; when an application stops running, the accumulation of the running time is paused; the accumulation of running time may be realized through a timer or other similar software modules.

In another specific embodiment, the usage count of the application is obtained by detecting the number of times the application is started; in particular, each time an application is detected starting running in a memory, the usage count is plus 1; the starting running refers to the started state of an application which is not started previously. When an application is started and starts running, the system broadcasts a notification message, through which a description information in the user manual about the application can be pushed on a lock screen interface.

In a preferred embodiment, when the smart phone is in a screen locked state, if the accumulated usage time or accumulated usage count of one application is lower than a set value, description information in the user manual about the application is pushed on a lock screen interface. Since lock screen itself is an application (APP), it is judged first during specific implementation steps whether the lock screen is already running; the method for judgment may acquire the current screen state by receiving a broadcast of the Android system; the system sends a broadcast when the screen switches among the screen started state, the screen locked state and the screen unlocked state, for example, acquiring the screen state by the method of intent.get Action ( ). In the screen locked state, although the screen does not display a normal startup desktop, the screen still has a function of displaying corresponding message notifications; therefore, in the following S300, the description information of a certain application may be sent to the notification bar on the lock screen interface. In this embodiment, a user can look the description information in the user manual about an application in a screen locked state without switching to a phone awaken state, thus the user may learn relevant functions the first time.

S300: when the accumulated usage time or accumulated usage count of one application is lower than a set value, pushing description information in the user manual about the application. When the accumulated usage time or accumulated usage count of one application is lower than a set value, it is indicated that this application has not been used by a user in a long period, the probable reason may be the user is not familiar with the function of this application and thus is not willing to use it, therefore, the user manual is called out to make a usage instruction and guide for the user.

The accumulated usage time refers to the usage time within a specific time interval, for example, the accumulated usage time within each month, namely, detecting the running time of one application starting from the first day of each month and accumulating the running time to count. When the accumulated time is lower than a set value, the description information of the user manual for this application is pushed to a user.

The accumulated usage count refers to the usage count within a specific time interval, for example, the accumulated usage count within each day, namely, detecting the running count of one application starting from a preset time (for example, 0:00) of each day, one time of running refers to an operation from the start of the application to the stop of the application, and accumulating the running count. When the accumulated count is lower than a set value, the description information of the user manual for this application is pushed to a user.

Preferably, the priority of the description information is a type of forced persistence. The priority of this type of information is only second to that of the information of the forced interruption type, that is to say, if there is other information pushed to the user, provided the other information does not belong to the information of the forced interruption type, the description information of the forced persistence type will not be replaced by the other information and will always be displayed for the user.

Moreover, in a preferred embodiment, S300 includes:

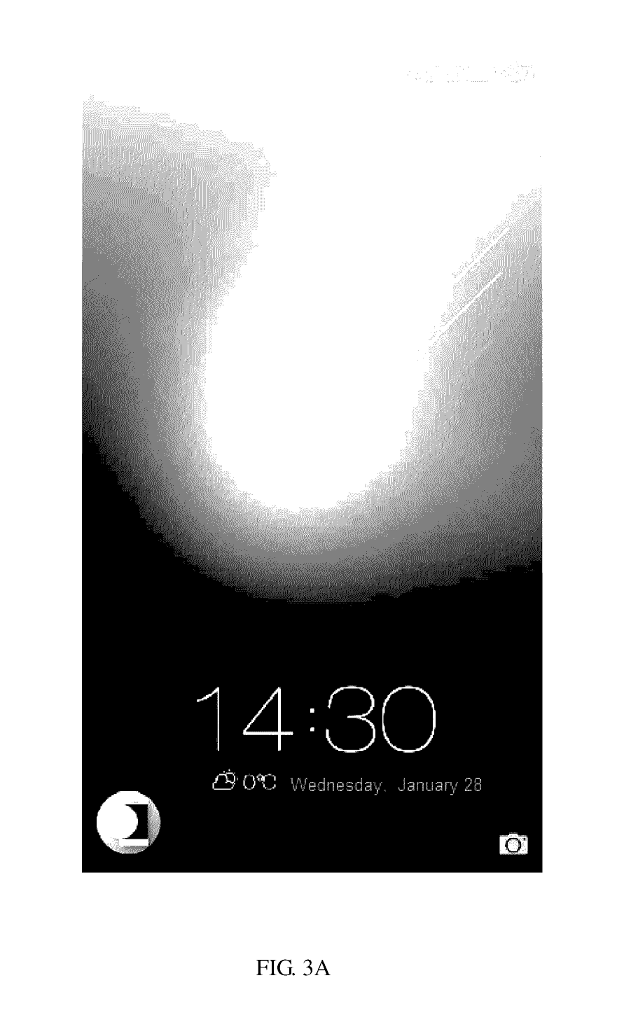

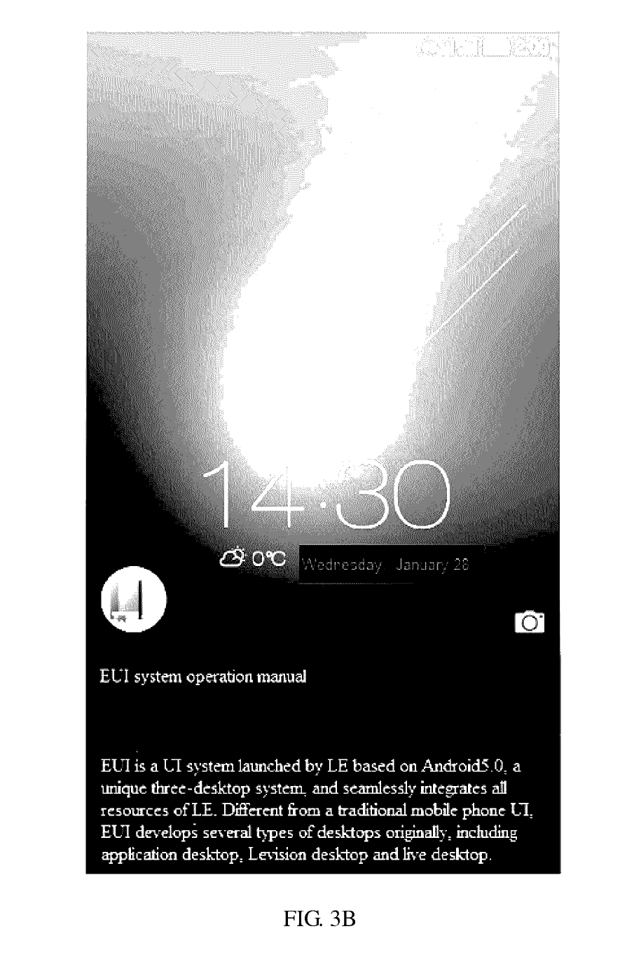

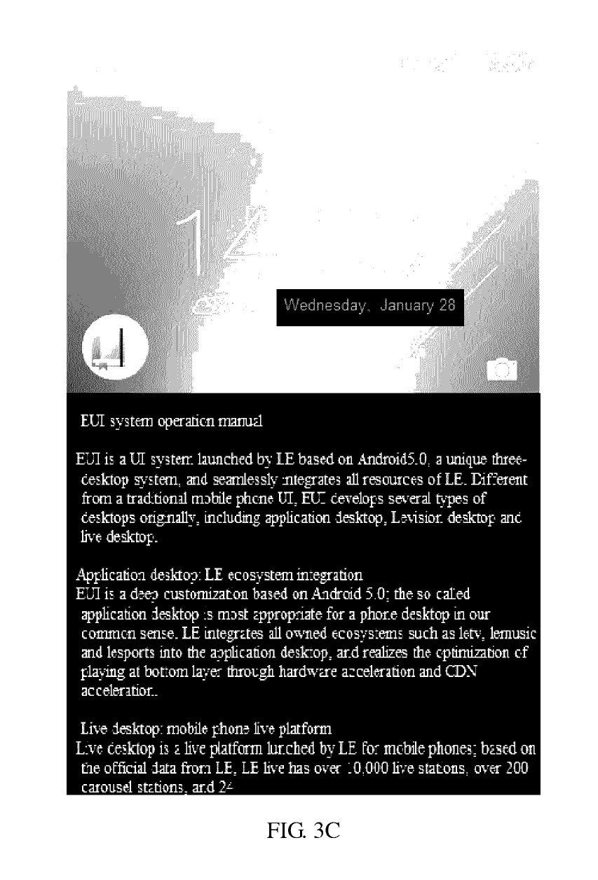

S310: when the accumulated usage time or accumulated usage count of one application is lower than a set value, sending a description information prompt. According to the processing logic in S200, when the accumulated usage time or accumulated usage count of one application is lower than a set value, a description information prompt is sent to a user first, wherein the prompt may be presented in the form of a prompt message, for example, a prompt on the circular button at the left bottom shown in FIG. 3A.

S320: receiving a touch input from a user for the description information prompt.

S330: displaying the description information according to the touch input. The touch input may be a touch signal input by a user to a touch screen through a finger or a device such as stylus. As shown in FIG. 3A and FIG. 3B, after a user clicks the description information prompt indicated by the circular icon at the left bottom shown FIG. 3A, FIG. 3B displays the current description information. If the first touch input of the user is to click the circular button and swipe up, more details of the description information are displayed as shown in FIG. 3C. This interactive operation allows a user to read the description information about a user manual more independently and more conveniently.

Correspondingly, the application further provides a user manual callout device 400 for a smart phone, wherein the device includes an application description setting unit 410, an application monitoring unit 420 and a manual push unit 430, in which,

the application description setting unit 410 is configured to set an application needing to be described. An application to be described needing the trigger of the content in a user manual is set; the set content includes the name of the application and the condition for triggering the user manual description of the application. In particular, the application description setting unit 410 may be realized through a software module which is capable of implementing parameter setting.

The application monitoring unit 420 is configured to accumulate the usage time or usage count of each application according to the set information. The accumulation includes two possible technical solutions: (1) accumulating the usage time of each application; (2) accumulating the usage count of each application. The accumulated usage time is realized through the statistics of the running time of the application, the running time of an application referring to the elapsed time from the start of the application to the stop of the application. Each time an application is detected starting running in a memory, the application is considered to have started; when an application stops running, the accumulation of the running time is paused; the accumulation of running time may be realized through a timer or other similar software modules.

The manual push unit 430 is configured to push description information in the user manual about one application when the accumulated usage time or accumulated usage count of the application is lower than a set value. The manual push unit 430 may be realized through a related man-machine display interface. Preferably, the priority of the description information is a type of forced persistence. When the smart phone is in a screen locked state, if the accumulated usage time or accumulated usage count of one application is lower than a set value, the manual push unit 430 pushes the description information in the user manual about the application on a lock screen interface; at this time, the manual push unit 430 displays the description information through the information in a lock screen program.

In a preferred embodiment, the manual push unit 430 includes: an information prompt module 431, a user input receiving module 432 and a display module 433, in which, the information prompt module 431 is configured to send a description information prompt when the accumulated usage time or accumulated usage count of one application is lower than a set value; the user input receiving module 432 is configured to receive a touch input from a user; and the display module 433 is configured to display the description information according to the touch input.

The embodiment of the present application provides a nonvolatile computer storage media in which computer executable instructions are stored, wherein the computer executable instructions is used for executing a method for user manual callouting in smart phone in any of above-described method embodiments.

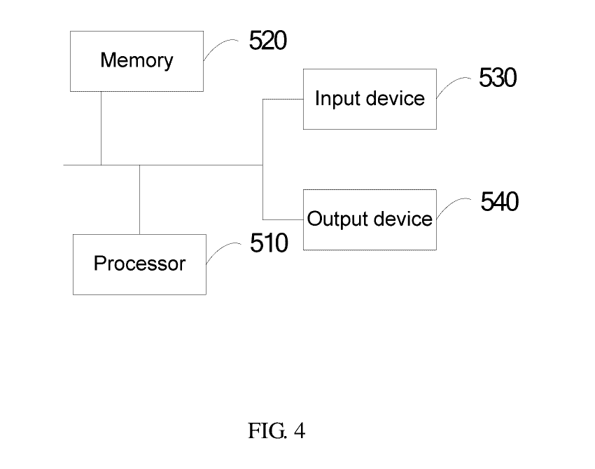

FIG. 4 is a schematic diagram illustrating a hardware structure of an electronic device of a method for user manual callouting in smart phone of the present application, as shown in FIG. 4, the device includes:

at least one processor 510 and a memory 520 communication connected with the at least one processor 510, where one processor 510 is taken as an example in FIG. 4.

The device for performing a method for user manual callouting in smart phone may further include: an input device 530 and an output device 540.

The processor 510, the memory 520, the input apparatus 530 and the output apparatus 540 can be connected by a bus or by other means, and a bus connection is taken as an example in FIG. 4.

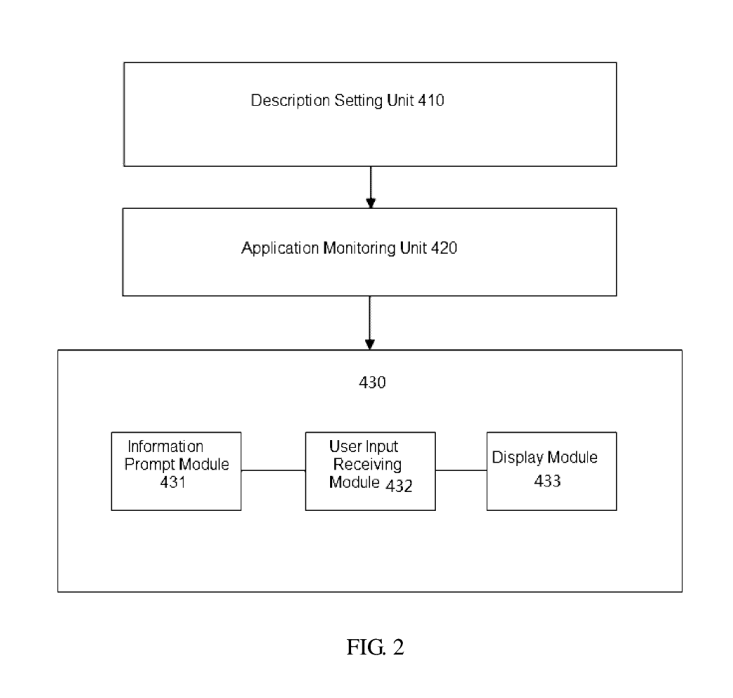

The memory 520, as a nonvolatile computer storage media, can be configured to store a nonvolatile software program, a nonvolatile computer-executable program and module, such as program instructions/modules corresponding to a method for user manual callouting in smart phone in embodiments of the present application (e.g., the application description setting unit 410, the application monitoring unit 420 and the manual push unit 430 as shown in FIG. 2). The processor 510 performs various functional applications and data processing in a server by running a nonvolatile software program, instruction and module stored in the memory 520, that is, to implement the method for user manual callouting in smart phone according to the above method embodiments.

The memory 520 may include a storage program area and a storage data area, where the storage program area can store an operating system, and an application program required by at least one function; the storage data area can store data created by use of the device for user manual callouting in smart phone and the like. In addition, the memory 520 may include a high-speed random access memory, or may further include a nonvolatile memory such as at least one magnetic disk storage device, a flash memory device, or other nonvolatile solid state storage device. In some embodiments, optionally, the memory 520 may include memories remotely located relative to the processor 510, and these remote memories can be connected to the device for user manual callouting in smart phone through a network. Examples of the above network include but are not limited to an Internet, an intranet, a local area network, a mobile communication network, and any combination thereof.

The input apparatus 530 can receive input number or character information, and generate key signal input associated with user settings and functional control of the device for user manual callouting in smart phone. The output apparatus 540 may include a display device such as a display screen.

The at least one module is stored in the above memory 520, when the at least one module is executed by the at least one processor 510, the at least one module executes the method for user manual callouting in smart phone according to any of the method embodiments.

The above product can perform the method provided in embodiments of the present disclosure, and have corresponding function modules and beneficial effects. Refer to the method provided in embodiments of the present disclosure for technical details, which are not described in detail in this embodiment.

The electronic device according to embodiments of the present disclosure exists in various forms, including but not limited to:

(1) mobile telecommunication device. A device of this kind has a feature of mobile communicating function, and has a main object of providing voice and data communication. Devices of this kind include smart phone (such as iphone), multi-media cell phone, functional cell phone, low-end cell phone and the like;

(2) ultra mobile personal computer device. A device of this kind belongs to a category of personal computer, has functions of computing and processing, and generally has a feature of mobile internet access. Devices of this kind include PDA, MID, UMPC devices and the like, such as iPad;

(3) portable entertainment device. A device of this kind can display and play multi-media content. Devices of this kind include audio and video player (such as iPod), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer storage media, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement does not make essential of corresponding technical solutions depart from spirits and scope of technical solutions of various embodiments.

What is claimed is:

1. A method for user manual callouting in smart phone, which is applied to terminal, comprising:
S100: setting an application needing to be described;
S200: accumulating the usage time or usage count of each application needing to be described according to the set information; and
S300: when the accumulated usage time or accumulated usage count of one application is lower than a set value, pushing description information of the application.

2. The method according to claim 1, wherein the S200 comprises: when the smart phone is in a screen locked state, if the accumulated usage time or accumulated usage count of one application is lower than a set value, pushing description information in the user manual about the application on a locked screen interface.

3. The method according to claim 2, wherein the S300 comprises:
S310: when the accumulated usage time or accumulated usage count of one application is lower than a set value, sending a description information prompt;
S320: receiving a touch input from a user for the description information prompt; and
S330: displaying the description information according to the touch input.

4. The method according to claim 1, wherein the S100 is setting an application needing to be described comprises setting an application needing to be described at a server and sending the set information to a phone terminal of a user.

5. The method according to claim 1, wherein the priority of the description information is a type of forced persistence.

6. A nonvolatile computer storage media which has computer executable instructions stored thereon, wherein the computer executable instructions are configured to:
S100: set an application needing to be described;
S200: accumulate the usage time or usage count of each application needing to be described according to the set information; and
S300: when the accumulated usage time or accumulated usage count of one application is lower than a set value, push description information of the application.

7. The nonvolatile computer storage media according to claim 6, wherein the S200 comprises:
when the smart phone is in a screen locked state, if the accumulated usage time or accumulated usage count of one application is lower than a set value, push description information in the user manual about the application on a locked screen interface.

8. The nonvolatile computer storage media according to claim 7, wherein the S300 comprises:
S310: when the accumulated usage time or accumulated usage count of one application is lower than a set value, send a description information prompt;
S320: receive a touch input from a user for the description information prompt; and
S330: display the description information according to the touch input.

9. The nonvolatile computer storage media according to claim 6, wherein the S100 is setting an application needing to be described at a server and sending the set information to a phone terminal of a user.

10. The nonvolatile computer storage media according to claim 6, wherein the priority of the description information is a type of forced persistence.

11. An electronic device, comprising:
at least one processor; and
a memory communicably connected with the at least one processor for storing instructions executable by the at least one processor, wherein execution of the instructions by the at least one processor causes the at least one processor to:
S100: set an application needing to be described;
S200: accumulate the usage time or usage count of each application needing to be described according to the set information; and
S300: when the accumulated usage time or accumulated usage count of one application is lower than a set value, push description information of the application.

12. The electronic device according to claim 11, wherein the S200 comprises: when the smart phone is in a screen locked state, if the accumulated usage time or accumulated usage count of one application is lower than a set value, push description information in the user manual about the application on a locked screen interface.

13. The electronic device according to claim 12, wherein the S300 comprises:
S310: when the accumulated usage time or accumulated usage count of one application is lower than a set value, send a description information prompt;
S320: receive a touch input from a user for the description information prompt; and
S330: display the description information according to the touch input.

14. The electronic device according to claim 11, wherein the S100 is setting an application needing to be described at a server and sending the set information to a phone terminal of a user.

15. The electronic device according to claim 11, wherein the priority of the description information is a type of forced persistence.
